(19) United States
(12) Patent Application Publication
(10) Pub. No.: US 2025/0319616 A1
(43) Pub. Date: Oct. 16, 2025

(54) ZERO GAP HAIR TRIMMER BLADESET WITH ADJUSTER

(71) Applicant: WAHL CLIPPER CORPORATION, Sterling, IL (US)

(72) Inventors: Gary Lee SNOW, Rock Falls, IL (US); Dhiraj BASNET, Dixon, IL (US)

(21) Appl. No.: 19/174,650

(22) Filed: Apr. 9, 2025

Related U.S. Application Data
(60) Provisional application No. 63/632,840, filed on Apr. 11, 2024.

(51) Int. Cl. B26B 19/06; B26B 19/20; B26B 19/28; B26B 19/38

(52) U.S. Cl. CPC B26B 19/063; B26B 19/205; B26B 19/28; B26B 19/388

(57) ABSTRACT

A hair trimmer bladeset for a hair trimmer includes a stationary blade having a stationary blade base and a plurality of stationary blade teeth projecting from a first edge of the stationary blade base, a moving blade having a moving blade base and a plurality of moving blade teeth projecting from a first edge of the moving blade base, the moving blade constructed and arranged to reciprocate laterally relative to the stationary blade. A blade guide is secured to the moving blade. The moving blade is configured for being slidably adjusted relative to the stationary blade and the blade guide in a direction transverse to the reciprocation. An adjuster is associated with the blade guide and is configured for moving the moving blade relative to the stationary blade upon user manipulation.

### RELATED APPLICATION

The present application claims the benefit under 35 USC 119(e) of U.S. Provisional Application No. 63/632,840 filed Apr. 11, 2024, the entire contents of which are incorporated by reference herein.

### BACKGROUND

The present invention relates generally to electric hair cutting devices, such as hair clippers and hair trimmers, and more specifically to bladesets for such devices. In particular, the present invention is related to bladesets designed for hair trimmers.

Conventional electric hair cutting devices include an electric motor having an output shaft with an offset cam engaging a bladeset. The bladeset includes a moving blade constructed and arranged to linearly reciprocate relative to a stationary blade. Both blades have complementary toothed edges, and the relative movement of the moving blade to the stationary blade creates a scissors-like cutting action. The bladeset is usually removable from the device for cleaning, sharpening and other maintenance. A suitable example of conventional hair cutting device bladeset design is disclosed in commonly-assigned U.S. Pat. No. 5,068,966, which is incorporated by reference.

Hair clippers are usually considered more powerful and used for relatively larger cutting jobs, such as providing a major portion of a haircut, while hair trimmers are used for more detailed operations, such as trimming beards, mustaches and the like, edging around a customer's scalp line, and creating artistic shapes in the scalp by trimming hair. As such, trimmer bladesets are often smaller in all dimensions than clipper bladesets. In the present application, both hair trimmers and hair clipper will be collectively referred to as hair trimmers.

One problem faced by trimmer bladeset designers is maintaining the alignment of the moving blade relative to the stationary blade during the entire reciprocal path of cutting operation. Any misalignment of the moving blade during reciprocation can cause poor cutting or nicking of the person receiving the trim.

Another problem faced by trimmer bladeset designers is providing the ability to move the position of the points or ends of the cutting teeth on the moving blade back and forth relative to the complementary teeth of the stationary blade in a direction transverse to the direction of blade cutting action, for the purposes of obtaining a cut closer to or farther from, the skin as desired. This feature is common on clipper bladesets, but it has been difficult to achieve in the smaller confines of a trimmer bladeset. For hair trimmers, detailed trimming is considered a more precise operation, which is best performed with tips of the moving blade teeth located adjacent tips of the stationary blade teeth. For general hair trimming, the tips of the moving blade teeth are retracted from their counterparts on the stationary blade, so that the stationary blade teeth project ahead of the moving blade teeth.

U.S. Pat. No. 7,350,314 discloses a stand-alone tool for use by stylists to manually adjust the gap of the blades using a fixture with preset stops for the desired blade positions. In use, the bladeset is removed from the hair trimmer, the blades placed in a guide/template receptacle and the moving blade secured in the desired position using a screwdriver to tighten appropriate bladeset mounting screws. While effective in setting the blade gap as desired, the use of this tool is considered time consuming by stylists.

Another stand-alone tool for stylists to use in setting the blade gap is disclosed in U.S. Pat. No. D962,544. While considered an improvement over the above-described U.S. Pat. No. 7,350,314, this unit also requires the stylist to set the blade gap with the blades removed from the trimmer.

An attempt in providing blade gap adjustment on the trimmer is disclosed in U.S. Pat. No. 9,545,729. However, in the '729 patent, the mechanism is configured for changing the blade gap by moving the stationary blade.

Thus, there is a need for an improved hair trimmer bladeset that addresses the hair trimmer design issues identified above.

### SUMMARY

The above-listed need is met or exceeded by the present zero gap hair trimmer bladeset with adjuster. A feature of the present bladeset is the ability of the user to adjust the blade gap, or the distance between respective teeth of the moving and stationary blades while the blades are mounted to the trimmer. The bladeset is configured for user-activated movement of the moving blade relative to the stationary blade and is adjustable between a so-called zero gap position, where the blade tips are closely adjacent each other, and a retracted position, with tips of the moving blade teeth being displaced away from the tips of the stationary blade teeth, in the direction of the trimmer housing. In an embodiment, the total travel of the moving blade tooth tips between the two positions is in the range of 0.040 inch, although other ranges are contemplated via the teachings herein.

In another embodiment, the adjustment of the trimmer blades is achieved by the user directly contacting the bladeset itself. A knurled wheel or thumbwheel located on the bladeset is rotated by the user to achieve the desired blade gap setting. The wheel is connected to a threaded stem that engages a blade guide of the bladeset. Also, the wheel itself has a large enough diameter that it engages a slot in a body of the moving blade. The moving blade is slidably secured to the stationary blade to achieve this adjustment, while still maintaining the traditional hair clipper drive system which moves the moving blade relative to the stationary blade to achieve cutting action.

Accordingly, rotation of the wheel changes the depth of engagement of the stem in the blade guide, and this movement also moves the moving blade, due to the engagement of the wheel in the slot. In an embodiment, the wheel is configured for receiving a tool, such as an Allen wrench, screwdriver or the like, to achieve the desired stem rotation/blade adjustment.

Another feature of the present bladeset is a cam follower, which both engages the blade guide and also includes locating lugs for engaging the moving blade and for maintaining proper moving blade alignment during the laterally reciprocating drive action that causes the hair clipping movement of the hair trimmer.

In a second embodiment of the present disclosure, a hair trimmer is provided with a digital display which displays the current blade gap. Additionally, the hair trimmer is provided with a processing unit which detects a manipulation of the wheel which causes adjustment of the blade gap. Specifically, the wheel is connected to a threaded stem that engages a blade guide of the bladeset, and advantageously is connected to at least one, and optionally two, sensors which are connected to the processing unit. In an embodiment, the sensors include a first sensor which detects rotation of the wheel, and a second sensor which detects the direction of rotation of the wheel.

Advantageously, the sensors are contact sensors which engage the wheel at a particular radial distance from a center of the wheel, such that the wheel and the contact sensors are made of a conductive material. In this embodiment, a positive lead applies a charge to the wheel, which passes through the wheel and to the contact sensors in certain instances. In this embodiment, the wheel also includes non-conductive material located along the radial path of each sensor, such that when one of the contact sensors is contacting the non-conductive material, the contact sensor does not have a current flowing through the contact sensor. When the processing unit detects a rotation of the wheel, the digital display is adjusted to reflect the change in the blade gap based on the direction of the wheel and the amount of rotation of the wheel.

More specifically, a hair trimmer bladeset for a hair trimmer includes a stationary blade having a stationary blade base and a plurality of stationary blade teeth projecting from a first edge of the stationary blade base, a moving blade having a moving blade base and a plurality of moving blade teeth projecting from a first edge of the moving blade base, the moving blade constructed and arranged to reciprocate laterally relative to the stationary blade. A blade guide is secured to the moving blade and configured for engaging a track in the stationary blade base. The moving blade is configured for being slidably adjusted relative to the stationary blade and the blade guide in a direction transverse to the reciprocation. An adjuster is associated with the blade guide and is configured for moving the moving blade relative to the stationary blade upon a manipulation of the adjuster.

In an embodiment, the adjuster includes a stem that is threadably engaged in the blade guide. Also, the adjuster is advantageously manipulated by rotating a wheel connected to the stem for rotating the stem relative to the blade guide.

In an embodiment, the wheel rotatably engages a slot in the moving blade. Advantageously, the wheel is configured for also being rotated by a tool. In an embodiment, the blade guide is provided with a vertically projecting mount configured for threadably accommodating a stem of the adjuster. Advantageously, the present bladeset includes a cam follower mounted to the moving blade, configured for receiving a drive member associated with the hair trimmer, and being mounted upon the blade guide. In an embodiment, the blade guide engages a track in the stationary blade base, and is provided with a vertically projecting adjuster housing configured for threadably accommodating a stem of the adjuster. In an embodiment, the adjuster is accessible by a user through the cam follower. In an embodiment, the cam follower is provided with locating lugs extending into complementary openings in the moving blade base for enhanced alignment control of the moving blade.

In another embodiment, a hair trimmer bladeset for a hair trimmer is provided, including a stationary blade having a stationary blade base and a plurality of stationary blade teeth projecting from a first edge of the stationary blade base; a moving blade having a moving blade base and a plurality of moving blade teeth projecting from a first edge of the moving blade base, the moving blade being constructed and arranged to reciprocate laterally relative to the stationary blade.

A blade guide is secured to the moving blade and configured for engaging a track in the stationary blade base; the moving blade is configured for being slidably adjusted relative to the stationary blade and the blade guide in a direction transverse to the reciprocation. A cam follower is configured for being driven by a drive member associated with the hair trimmer, the cam follower being mounted to the blade guide; and an adjuster is associated with the blade guide, being accessible through the cam follower and configured for moving the moving blade relative to the stationary blade upon a manipulation of the adjuster.

A second embodiment of the present disclosure includes a hair trimmer with a housing, a stationary blade mounted to the housing and having a stationary blade base and a plurality of stationary blade teeth projecting from a first edge of the stationary blade base, a moving blade having a moving blade base and a plurality of moving blade teeth projecting from a first edge of the moving blade base, the moving blade constructed and arranged to reciprocate laterally relative to the stationary blade, a blade guide secured to the moving blade, the moving blade configured for being slidably adjusted relative to the stationary blade and the blade guide in a direction transverse to the reciprocation, an adjuster associated with the blade guide and configured for moving the moving blade relative to the stationary blade by manipulation of the adjuster, and a processing unit configured to detect the manipulation of the adjuster.

In an embodiment, the hair trimmer also includes a digital display disposed on the housing, such that the digital display is connected to the processing unit, and is configured to display a blade gap between the moving blade and the stationary blade. In another embodiment, the adjuster is a wheel connected to a stem threadably engaging the blade guide, such that the wheel is configured for accommodating a tool for optional rotation of the stem.

In a further embodiment, the hair trimmer includes a first sensor which detects a rotation of the adjuster based on the manipulation, such that the processing unit registers the rotation of the adjuster and determines a change in a blade gap between the moving blade and the stationary blade based on the manipulation. Advantageously, the first sensor includes an electrical contact which engages the adjuster, such that the first sensor detects the rotation of the adjuster based a change in a current flowing through the first sensor.

In yet another embodiment, the hair trimmer includes a second sensor which detects a direction of rotation of the adjuster based on the manipulation, such that the processing unit registers the direction of rotation of the adjuster. Advantageously, the second sensor includes an electrical contact which engages the adjuster, such that the second sensor detects the direction of the rotation of the adjuster based on a change in a current flowing through the second sensor. In a further embodiment, the hair trimmer includes a cam follower acting upon the moving blade, configured for receiving a drive member associated with the hair trimmer, and being mounted upon the blade guide.

### BRIEF DESCRIPTION OF THE DRAWINGS

FIG. 1 is a fragmentary top perspective view of a first embodiment of a hair trimmer equipped with the present zero gap bladeset with adjuster;

FIG. 2 is a fragmentary top perspective of the hair trimmer of FIG. 1 with a top housing half removed;

FIG. 3 is a top perspective view of a first embodiment of the present assembled bladeset;

FIG. 4 is a fragmentary top perspective view of the bladeset of FIG. 3:

FIG. 5 is a side perspective view of a first embodiment the present adjuster;

FIG. 6 is an exploded perspective view of the present bladeset;

FIG. 7 is a top perspective view of a prior art moving hair trimmer blade;

FIG. 8 is a top perspective view of the present moving blade;

FIG. 9 is a top perspective view of a first embodiment of the present blade guide;

FIG. 10 is a top perspective view of a first embodiment of the present cam follower;

FIG. 11 is a bottom perspective view of the first embodiment of the present cam follower;

FIG. 12 is a top perspective view of a first embodiment of the present guide wheel and stem;

FIG. 13 is a vertical cross-section of the first embodiment of the present bladeset in a zero gap adjustment position used for detail trimming;

FIG. 14 is a vertical cross-section of the first embodiment of the present bladeset with the moving blade located in a general cutting position;

FIG. 15 is a vertical cross-section of the first embodiment of the present bladeset illustrating the mounting of the cam follower to the blade guide;

FIG. 16 is a fragmentary top perspective view of a hair trimmer equipped with a second embodiment of the present zero gap bladeset with adjuster;

FIG. 17 is a fragmentary top perspective of the hair trimmer of FIG. 16 with a top housing half removed;

FIG. 18 is a top perspective view of a second embodiment of the present moving blade assembly;

FIG. 19 is an exploded perspective view of the second embodiment of the present moving blade assembly of FIG. 18;

FIG. 20 is a top perspective view of a second embodiment of the present blade guide;

FIG. 21 is a top perspective view of a second embodiment of the present cam follower;

FIG. 22 is a bottom perspective view of the second embodiment of the present cam follower;

FIG. 23 is a top perspective view of a second embodiment the present gap adjuster assembly;

FIG. 24 is a front plan view of a second embodiment of the present guide wheel and stem;

FIG. 25 is a vertical cross-section of the second embodiment of the present bladeset with the moving blade located in a general cutting position;

FIG. 26 is a side perspective view of a dial blade gap adjuster and the second embodiment of the present blade guide;

FIG. 27 is a schematic diagram illustrating a processing unit, the dial blade gap adjuster, and a display screen of the hair trimmer of FIG. 16; and

FIG. 28 is a flow chart illustrating a method for determining a change in a blade gap of a moving blade relative to a stationary blade of the hair trimmer of FIG. 16.

### DETAILED DESCRIPTION

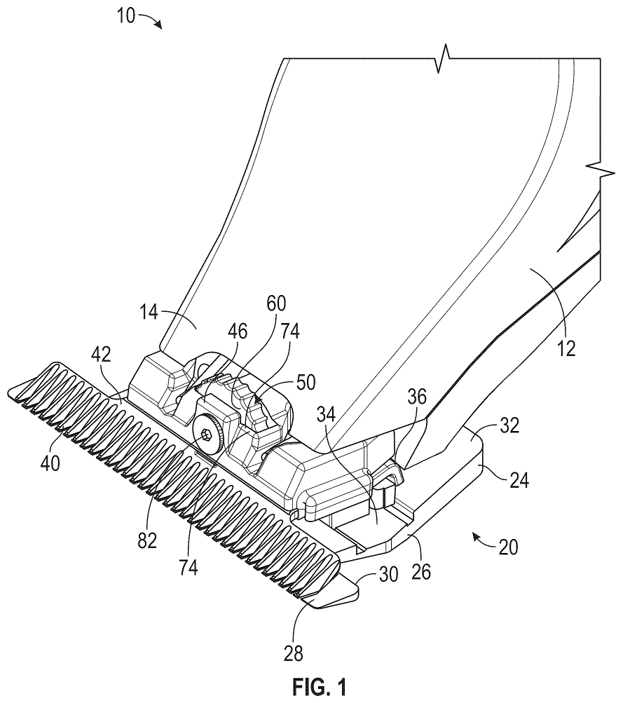

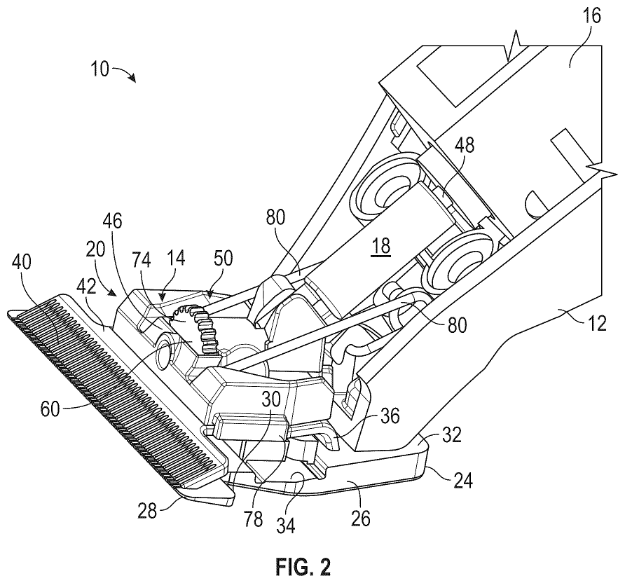

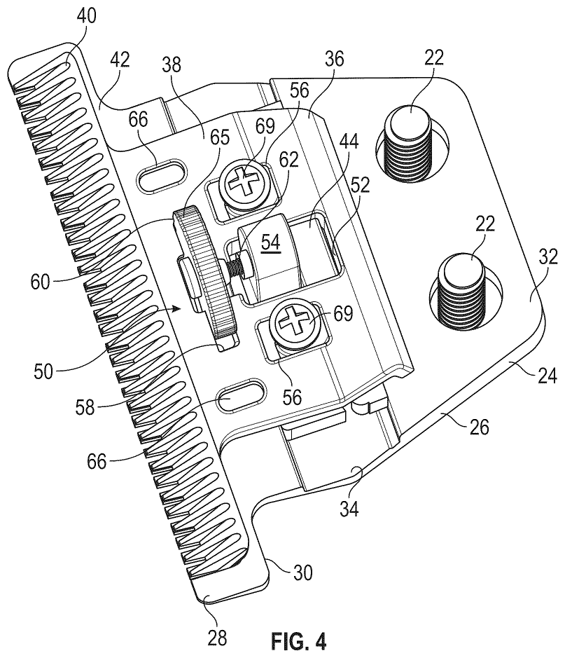

Referring now to FIGS. 1 and 2, a hair trimmer is generally designated 10 and includes a trimmer housing 12 with a front or blade end 14. An electric motor 16 drives an eccentric cam 18. A trimmer bladeset, generally designated 20 is releasably secured to the front end 14 by fasteners 22 (FIG. 4). The bladeset 20 includes a stationary blade 24 having a stationary blade base 26 and a plurality of stationary blade teeth 28 projecting from a first edge 30. An upper surface 32 of the stationary blade 24 has a transverse track 34 described in further detail below. A moving blade 36 has a moving blade body 38 (FIG. 4) with a plurality of moving blade teeth 40 projecting from a front edge 42. As is well known in the hair trimmer art, the moving blade 36 is constructed and arranged to reciprocate laterally relative to the stationary blade through the connection to the eccentric drive cam 18 driven by the electric motor 16. This reciprocal movement creates the hair cutting action of the hair trimmer 10.

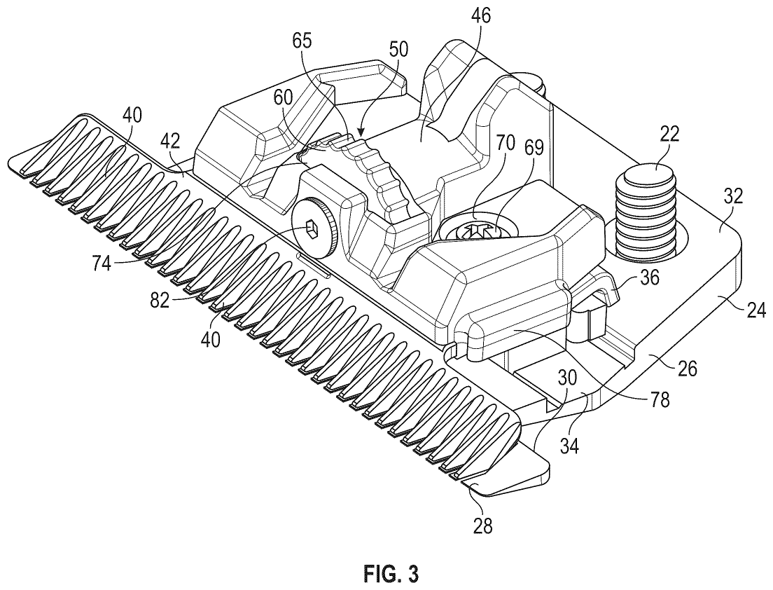

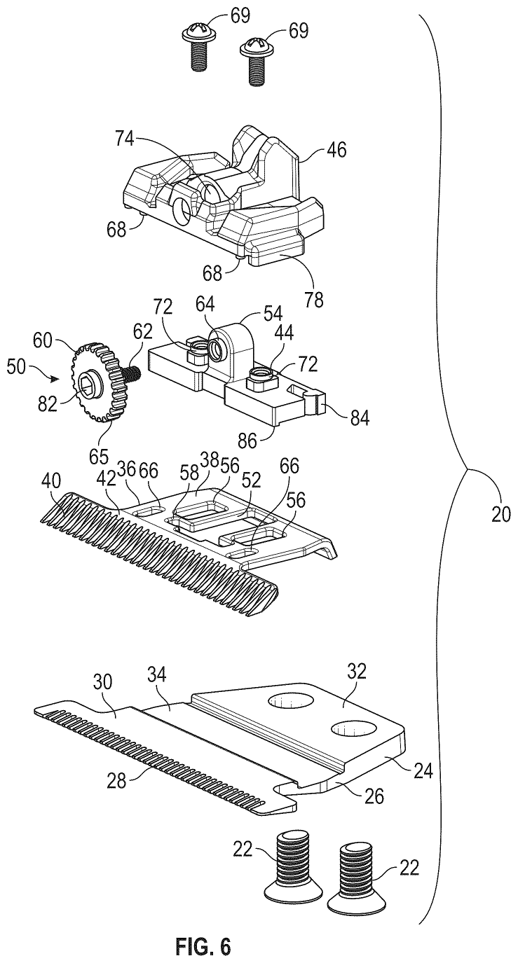

Referring now to FIGS. 4-6, included on the bladeset 20 is a blade guide 44 which enhances reliable reciprocal movement of the moving blade 36 by having a portion that slidingly engages the transverse track 34 in the stationary blade 24. In conventional hair trimmer bladesets, the blade guide is engaged and driven by a cam follower 46 that itself is engaged by the eccentric cam 18 (FIG. 2) connected to a motor shaft 48 (FIG. 2) which provides the driving force for the moving blade. The cam follower 46 is mounted upon the blade guide 44 with a portion of the moving blade 36 interposed between the cam follower 46 and the blade guide 44 as shown for example in FIG. 3.

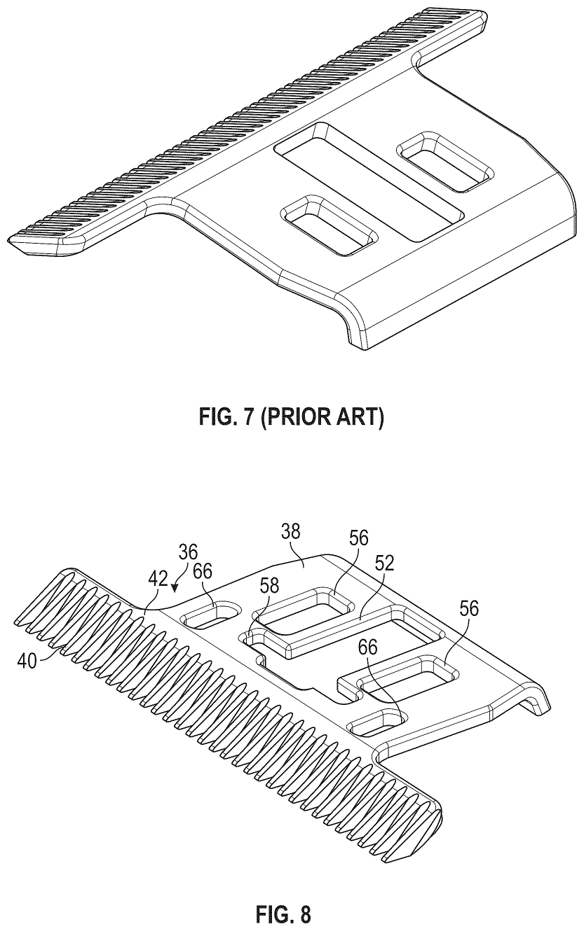

Referring now to FIGS. 4-8, however, in contrast to conventional hair trimmers, in the present bladeset 20, the blade guide 44 is the mounting point for the present blade gap adjuster, generally designated 50. Accommodation of the blade gap adjuster 50 is achieved by modifying the moving blade body 38 to have additional slots and apertures. FIG. 7 depicts a conventional hair trimmer moving blade. FIG. 8 depicts the moving blade 36 used in the present bladeset 20. A main aperture 52 receives a vertically projecting mount or adjuster housing 54 that is advantageously an integral part of the blade guide 44. A pair of cam follower attachment openings 56 are situated on either side of the main aperture 52. In communication with the main aperture is a laterally projecting adjuster wheel slot 58 that accommodates movement of an adjuster guide wheel 60 (FIGS. 4-6 and 12).

The adjuster guide wheel 60, advantageously made of a durable material such as stainless steel, is fixed to a threaded stem 62 that threadably engages a threaded bore 64 in the adjuster housing 54 of the blade guide 44. Since, besides the blades 24, 36, most of the components of the bladeset 20 are made of injection molded plastic, the threaded bore 64 is a metal thread insert that is insert molded, friction fit, secured by adhesive, fixed by ultrasonic welding or otherwise fixed to the adjuster housing 54 using any mechanical joining technology.

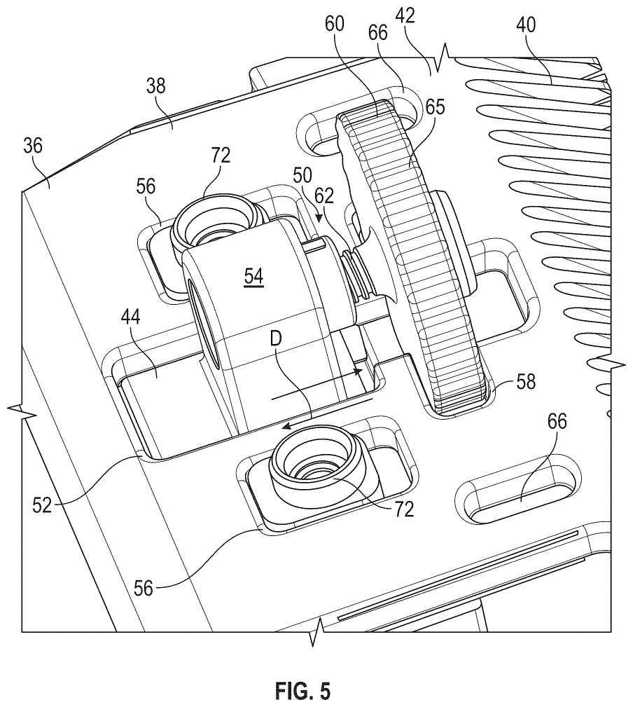

It will be seen that the moving blade 36 is slidable relative to the stationary blade 24 in a direction “D” (FIG. 5) transverse to the reciprocation of the moving blade 36 relative to the stationary blade 24. Such sliding movement is due to the clearance provided by the configuration of both the main aperture 52 and the cam follower attachment openings 56.

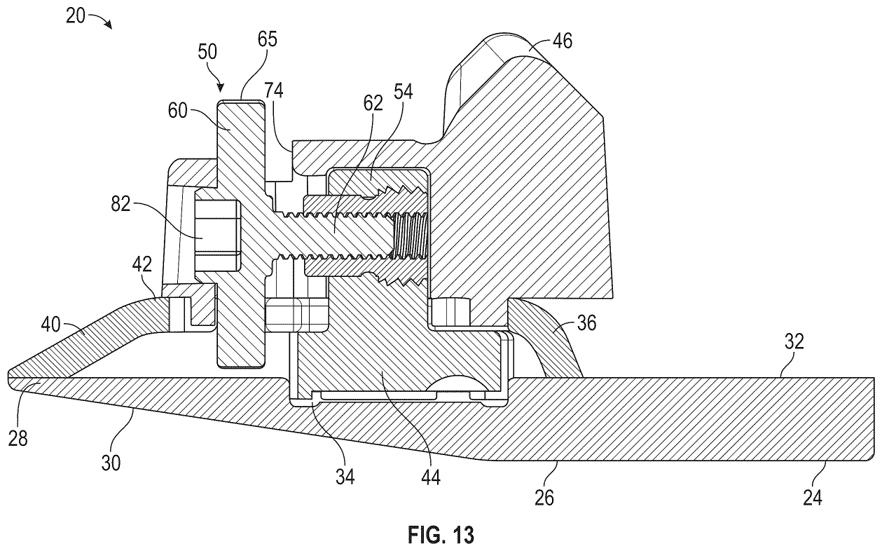

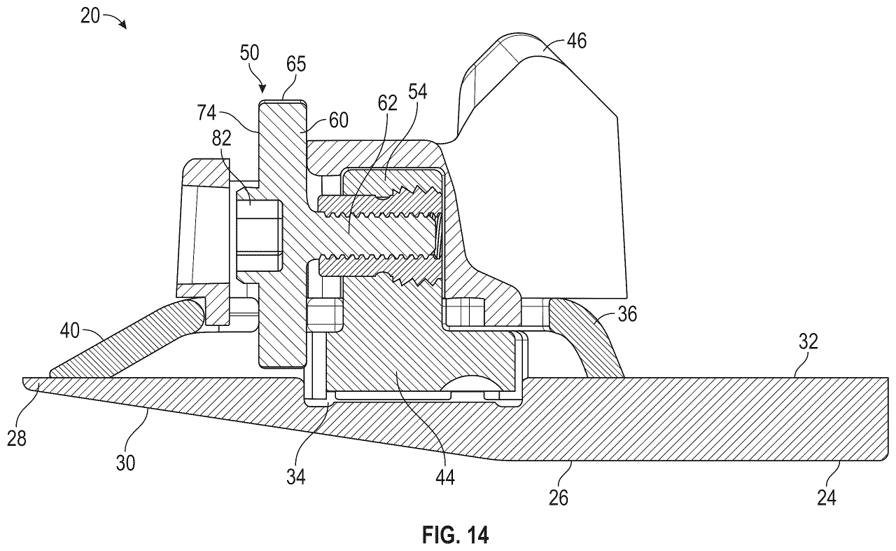

Thus, referring now to FIGS. 4, 5, 13, and 14, it will be seen that as the adjuster guide wheel 60 is rotated, since it is rotatably engaged in the adjuster wheel slot 58, threaded movement of the threaded stem 62 into and out of the threaded bore 64 will cause the guide wheel 60 to abut opposing side faces (depending on the direction of rotation of the guide wheel 60) of the adjuster wheel slot 58 to thereby cause the moving blade 36 to move relative to the stationary blade 24 in the directions “D”. As shown, the guide wheel 60 advantageously has a knurled or checkered periphery 65 for enhancing user grip. FIG. 13 illustrates the bladeset 20 in a so-called zero gap position, with the teeth 40, 28 of the moving blade 38 and the stationary blade 24 closely adjacent each other. In FIG. 14, the bladeset 20 is shown in a general cutting position, with the moving blade teeth 40 displaced rearwardly from the stationary blade teeth 28. The total range of movement of the moving blade 24 by the adjuster 50 is advantageously in the range of 0.040 inch (±0.010 inch), but it will be recognized that other values may be utilized based on thread pitch of the threaded stem 62, as well as the overall available clearance for movement of the moving blade 36.

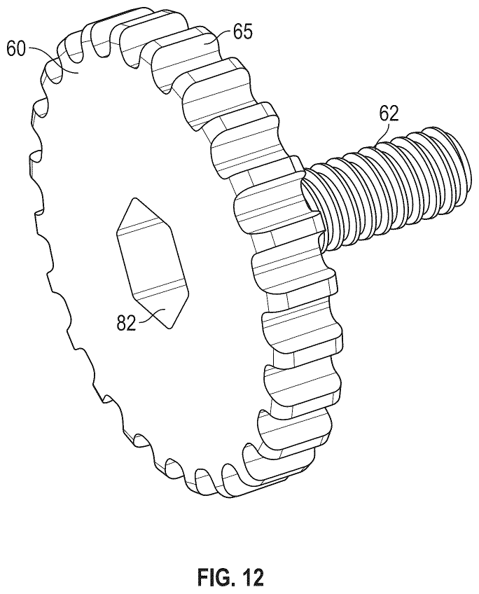

Returning now to FIGS. 5, 6 and 8, another enhancement of the present moving blade 36 is the addition of cam follower locating openings 66 located on the moving blade body 38 relatively closer to the front edge 42 than the cam follower attachment openings 56. These openings 66 are arranged on the blade body 38 to matingly receive depending locating lugs 68 (FIG. 11) attached to the cam follower 46. Thus, as the cam follower 46 is moved reciprocally by the eccentric cam 18, the engagement of the locating lugs 68 in the complementary cam follower attachment openings 66 maintains proper alignment of the moving blade 36 throughout the reciprocal action relative to the stationary blade 24. More specifically, the locating lugs 68 ensure acceptable parallelism of a line defined by the tips of the moving blade teeth 40 with a line defined by the tips of the stationary blade teeth 28. Put differently, the locating lugs 68 reduce or eliminate the tendency for the moving blade 36 to rock askew as it slides forward and rearward as described herein.

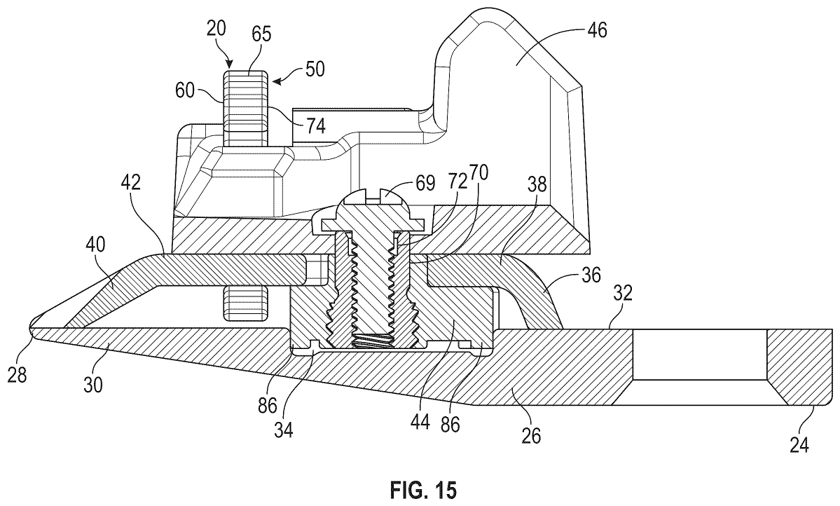

Referring now to FIGS. 3, 5, 6, 11 and 15, the cam follower 46 is mounted upon the blade guide 44 using fasteners 69 passing through mounting holes 70 in the cam follower and engaging threaded bores 72 of the blade guide 44. Thus, the cam follower 46, the blade guide 44 and the moving blade 36 move as a unit during the hair trimmer cutting action. Also, it will be seen that the adjuster guide wheel 60 is accessible by the user through a guide wheel port 74 in the cam follower 46. The cam follower 46 also has a pocket 76 (FIG. 11) dimensioned for accommodating the vertically projecting adjuster housing 54.

As seen in FIG. 11, the cam follower 46 is also advantageously provided with depending guide ribs 78 that engage the moving blade 36 and thus enhance the proper alignment of the moving blade described above. As known in conventional bladesets, the bladeset 20 is acted upon by springs 80 (FIG. 2) that exert a biasing force upon the cam follower 46 as it engages the moving blade 36.

Referring now to FIGS. 3, 6 and 12, another feature of the bladeset 20 is that the adjuster guide wheel 60 is provided with a noncircular aperture or bore 82 that is configured for receiving a tool as needed to adjust the threaded position of the stem 62 in the threaded bore 64 and thus achieve the desired blade gap. In the present embodiment, the aperture 82 is hex-shaped to accommodate an Allen wrench, however other shapes are contemplated, such as for accommodating screwdrivers or the like. This feature adds an additional means of adjustment in the event a tool is preferred over one's finger for turning the guide wheel 60. As will be understood, in such a configuration, a tool manipulation removes the necessity for the aforementioned knurled periphery 65. Additionally, the use of an Allen wrench may in some instances provide for more accurate positioning of the moving blade 36 relative to the stationary blade 24. It is also contemplated that the accessibility of the adjuster 50 from an exterior of the housing 12 may be omitted. In such an embodiment, the housing 12 would fully enclose the adjuster 50. An opening in the housing 12 may still remain in such an embodiment such that the adjuster 50 may still be manipulated using a tool such as the above-described Allen wrench.

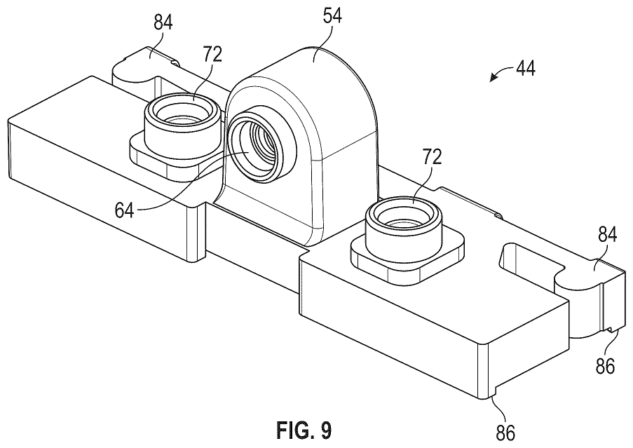

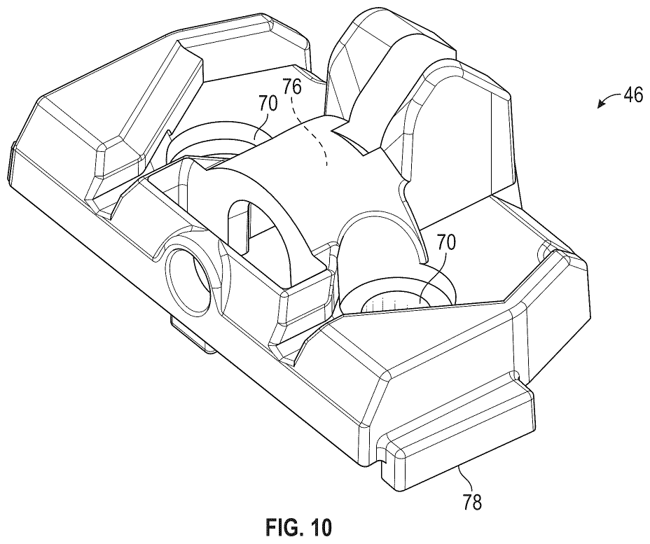

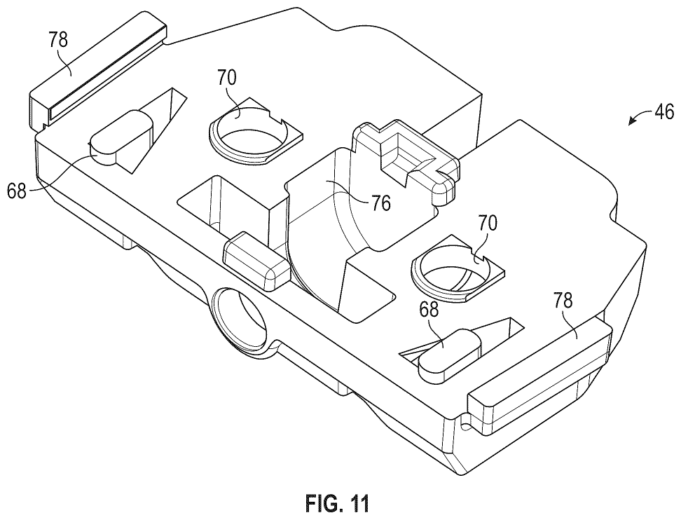

Referring now to FIG. 9, the blade guide 44 is advantageously provided with at least one and advantageously two integral biasing arms 84 to enhance the sliding engagement in the transverse track 34 of the stationary blade 24. Reduced blade guide sliding friction is achieved by the use of depending ribs 86 which engage the track 34.

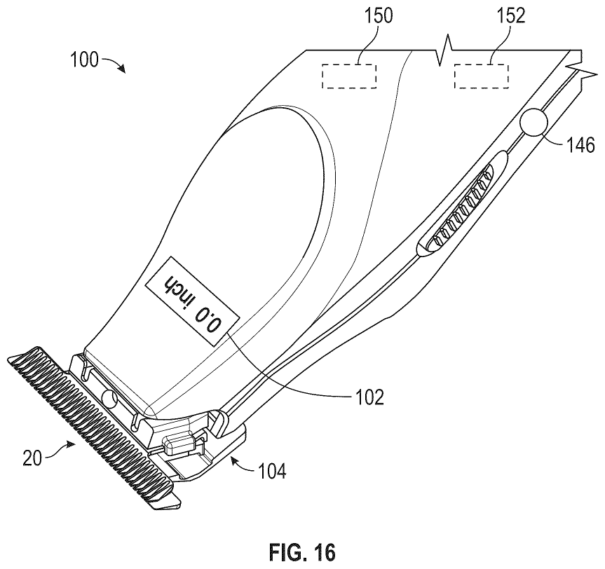

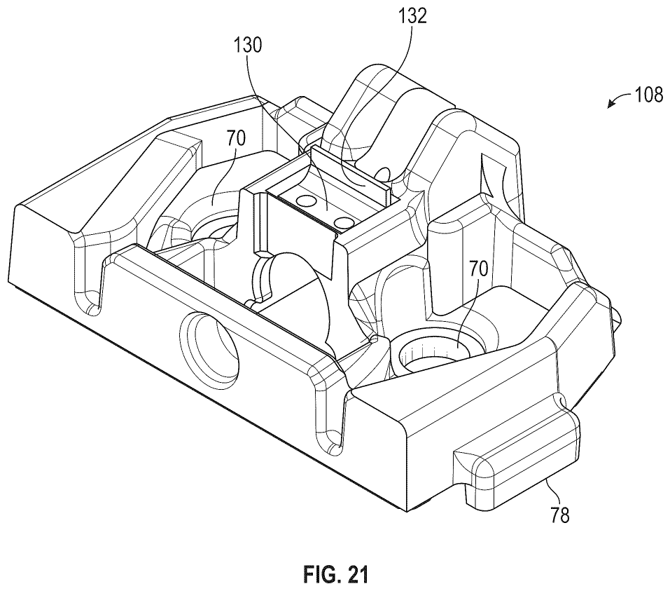

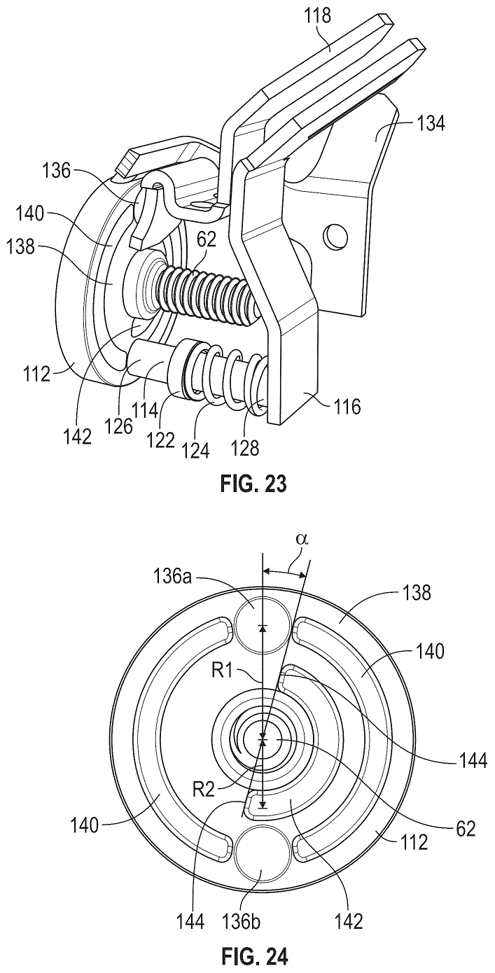

Referring now to FIGS. 16-28, a second embodiment of the hair trimmer is generally designated 100. Elements which the hair trimmer 100 shares with the hair trimmer 10 are show with identical reference numbers. Advantageously, the second embodiment of the hair trimmer 100 includes a digital display 102 on the trimmer housing 12, which is discussed in greater detail below.

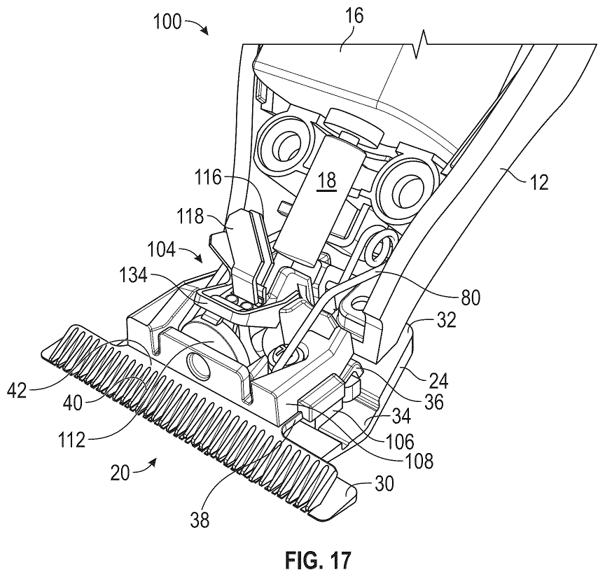

Referring to FIGS. 17-25, the hair trimmer 100 has a moving blade assembly 104 which includes a blade guide 106, a cam follower 108, an adjuster housing 110, a dial blade gap adjuster 112, a contacting pin 114, a first contact sensor 116, and a second contact sensor 118. Specifically, the blade guide 106 is similar to the blade guide 44 which enhances reliable reciprocal movement of the moving blade 36 by having a portion that slidingly engages the transverse track 34 in the stationary blade 24. As with the first embodiment of the hair trimmer 10, the blade guide 106 is the mounting point for the dial blade gap adjuster 112. Accommodation of the dial blade gap adjuster 112 is achieved by modifying the additional slots and apertures of the moving blade body 38 as described above. In particular, the main aperture 52 receives the vertically projecting mount or adjuster housing 110 that is advantageously an integral part of the blade guide 106. The laterally projecting adjuster wheel slot 58 accommodates the dial blade gap adjuster 112.

Additionally, the blade guide 106 advantageously includes an opening 120 through which extends the contacting pin 114. In the second embodiment, the contacting pin 114 advantageously includes a flange 122 against which a compression spring 124 presses, such that an opposite end of the compression spring contacts a surface of the blade guide 106. In this way, the contacting pin 114 is biased toward the dial blade gap adjuster 112, such that the contacting pin remains in contact with the dial blade gap adjuster regardless of the configuration of the dial blade gap adjuster, which is discussed in greater detail below. The contacting pin 114 advantageously includes a first end 126 which engages the dial blade gap adjuster 112, and an opposite second end 128 which engages the first contact sensor 116.

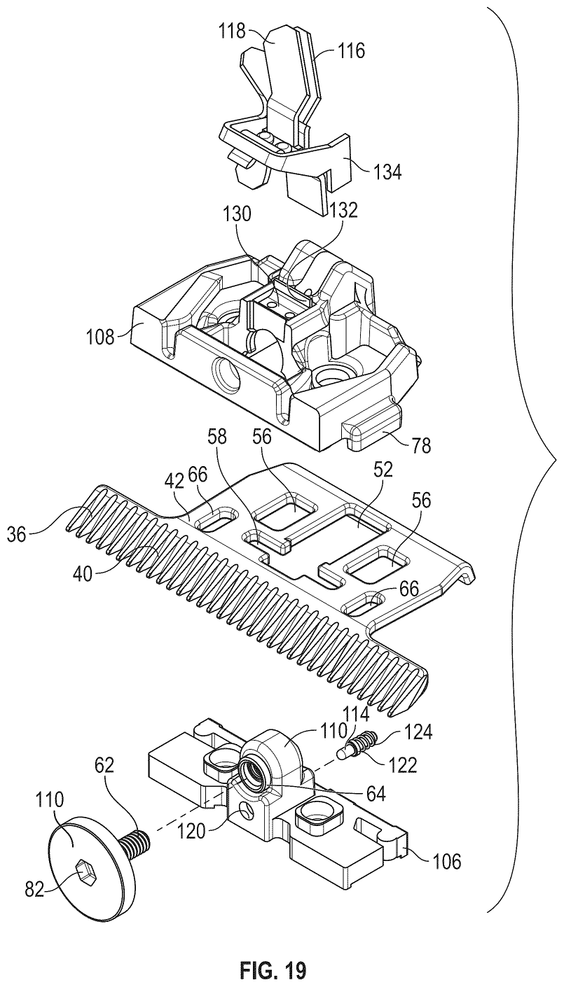

As with the first embodiment of the hair trimmer 10, the blade guide 106 is advantageously provided with at least one and advantageously two integral biasing arms 84 to enhance the sliding engagement in the transverse track 34 of the stationary blade 24. The cam follower 108 is mounted upon the blade guide 106 with a portion of the moving blade 36 interposed between the cam follower and the blade guide as shown for example in FIG. 19.

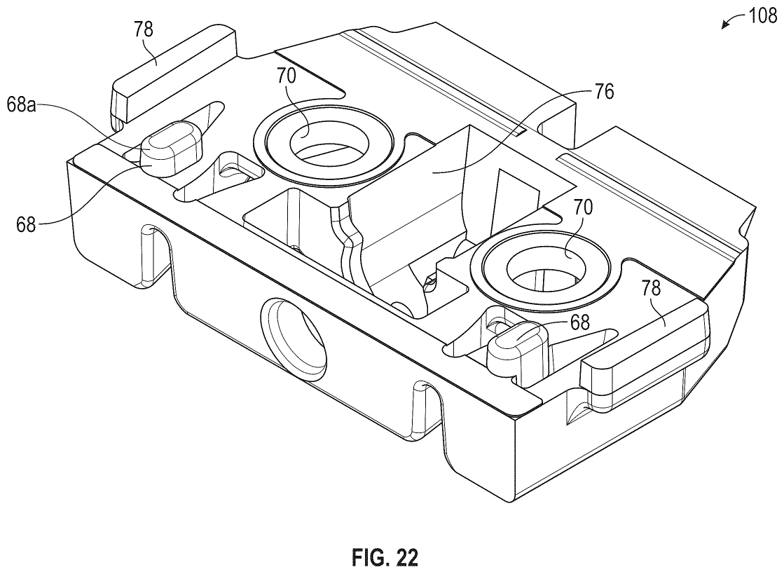

The cam follower 108 is similar to the cam follower 46, and also advantageously is provided with depending guide ribs 78 that engage the moving blade 36 and thus enhance the proper alignment of the moving blade described above. As known in conventional bladesets, the bladeset 20 is acted upon by springs 80 (FIG. 17) that exert a biasing force upon the moving blade 36. Moreover, the depending locating lugs 68 (FIG. 22) attached to the cam follower 108 are matingly received by the cam follower locating openings 66 on the blade body 38. Advantageously, an outer edge 68a of the locating lugs 68 is rounded.

Thus, as the cam follower 108 is moved reciprocally by the eccentric cam 18, the engagement of the locating lugs 68 in the complementary cam follower attachment openings 66 maintains proper alignment of the moving blade 36 throughout the reciprocal action relative to the stationary blade 24, as with the cam follower 46.

The cam follower 108 also advantageously includes a landing 130 which is used to secure the second contact sensor 118 to the cam follower that may also be insert molded directly during the manufacture of cam follower 108. Connected to the landing 130 is a separator 132 which advantageously creates a space between the first contact sensor 116 and the second contact sensor 118, such that the first and second contact sensors are disposed on opposite sides of the separator. As a result, the first contact sensor 116 and the second contact sensor 118 are prevented from contacting one another.

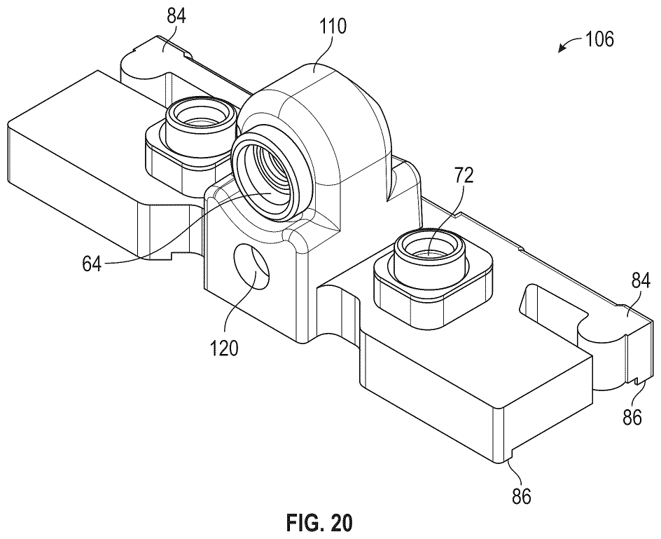

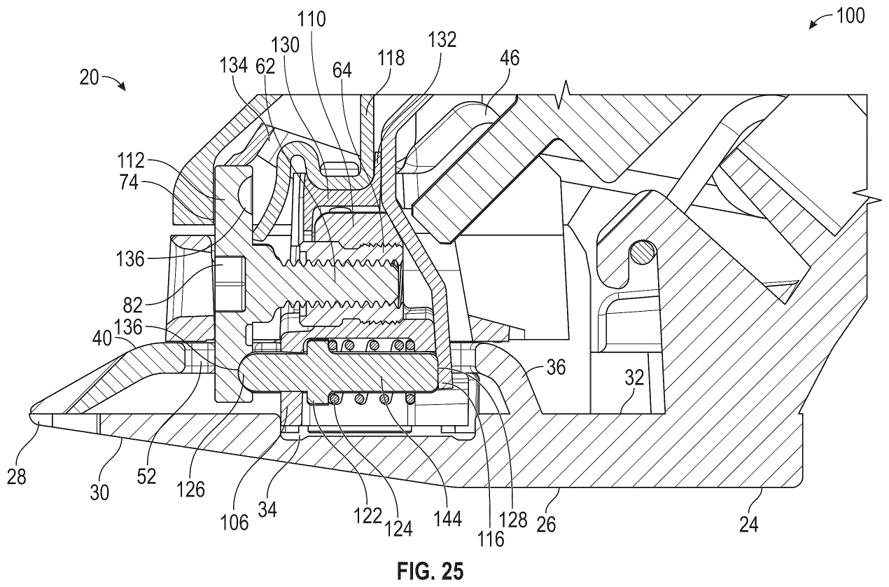

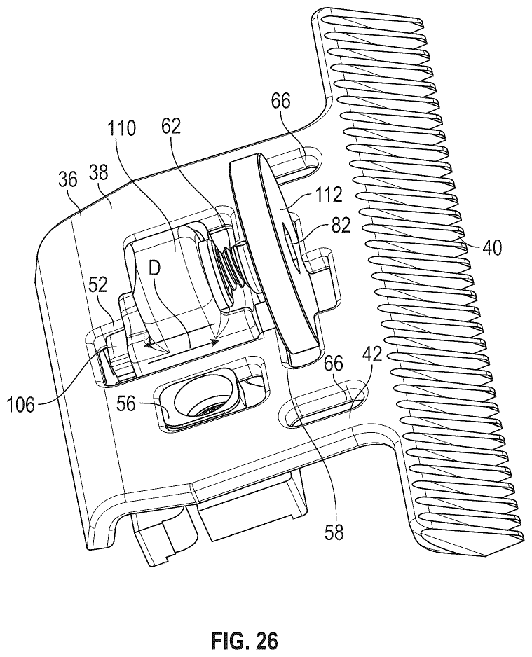

As shown in FIGS. 25-26, the dial blade gap adjuster 112 is accommodated by the laterally projecting adjuster wheel slot 58 in the moving blade 36. The dial blade gap adjuster 112 is made of an electrically conductive material, advantageously a durable material such as stainless steel, and is fixed to the threaded stem 62 that threadably engages the threaded bore 64 (FIG. 20) in the adjuster housing 110.

As shown in FIG. 26, the moving blade 36 is slidable relative to the stationary blade 24 in the direction “D” transverse to the reciprocation of the moving blade 36 relative to the stationary blade 24. Thus, when the dial blade gap adjuster 112 is rotated or otherwise manipulated, since it is rotatably engaged in the adjuster wheel slot 58, threaded movement of the threaded stem 62 into and out of the threaded bore 64 will cause the dial blade gap adjuster to abut opposing side faces (depending on the direction of rotation of the dial blade gap adjuster) of the adjuster wheel slot 58 to thereby cause the moving blade 36 to move relative to the stationary blade 24 in the directions “D”. As with the hair trimmer 10, the moving blade 36 of the hair trimmer 100 is optionally moved to be in the so-called zero gap position, or the general cutting position, with the moving blade teeth 40 displaced rearwardly from the stationary blade teeth 28. The total range of movement of the moving blade 24 by the dial blade gap adjuster 112 is advantageously in the range of 0.040 inch (±0.010 inch), but it will be recognized that other values may be utilized based on thread pitch of the threaded stem 62, as well as the overall available clearance for movement of the moving blade 36.

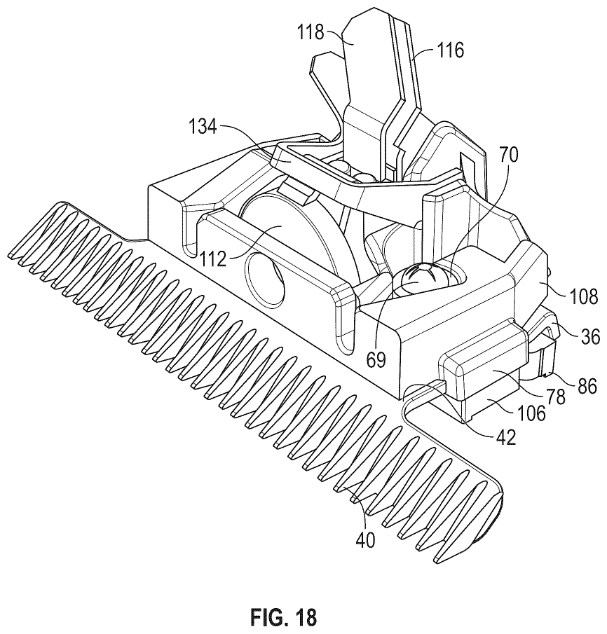

Referring now to FIG. 18, the cam follower 108 is mounted upon the blade guide 106 using the fasteners 69 passing through the mounting holes 70 in the cam follower and engaging the threaded bores 72 of the blade guide. Thus, the cam follower 108, the blade guide 106 and the moving blade 36 move as a unit during the hair trimmer cutting action. The cam follower 108 also has a pocket 76 (FIG. 22) dimensioned for accommodating the vertically projecting adjuster housing 110.

Referring now to FIGS. 19 and 25, another feature of the bladeset 20 is that the dial blade gap adjuster 112 is provided with the noncircular aperture or bore 82 that is configured for receiving a tool as needed to adjust the threaded position of the stem 62 in the threaded bore 64 and thus achieve the desired blade gap.

A positive lead 134 is advantageously disposed above the dial blade gap adjuster 112 in contacting relationship and provides an electrical charge to the dial blade gap adjuster. Thus, the dial blade gap adjuster 112 is electrically charged to a specific voltage which is provided by the positive lead 134. The dial blade gap adjuster 112 also includes depressions 136 within a face 138 of the dial blade gap adjuster which receive the first end 126 of the contacting pin 114. In an advantageous embodiment, the dial blade gap adjuster 112 includes a first depression 136a and a second depression 136b which are displaced a distance equal to a radius R1 from a center of the dial blade gap adjuster and provided 180 degrees apart from one another, such that the two depressions are on opposite sides of the threaded stem 62.

The first and second depressions 136a, 136b are formed of the same electrically conductive material as the dial blade gap adjuster 112, such that when contacting pin 114 engages one of the depressions 136a, 136b, a current flows through the positive lead 134, the dial blade gap adjuster, the contacting pin, and the first contact sensor 116, forming a complete circuit. Advantageously, when the dial blade gap adjuster 112 is rotated such that the contacting pin 114 engages one of the depressions 136a, 136b, an audible noise is created, indicating engagement between the contacting pin and one of the depressions 136a, 136b.

Between the first and second depressions 136a, 136b, the dial blade gap adjuster 112 includes two outer semicircular non-conductive tracks 140, where a radius of curvature of the outer semicircular non-conductive tracks is equal to the radius R1. Advantageously, the outer semicircular non-conductive tracks 140 are made of plastic or another non-electrically conductive material. As such, when the dial blade gap adjuster 112 is rotated between the first and second depressions 136a, 136b, the contacting pin 114 engages the outer semicircular non-conductive tracks 140, and current does not flow through the contacting pin or the first contact sensor 116. However, when the dial blade gap adjuster 112 has been rotated 180 degrees, such that the contacting pin 114 engages either the first depression 136a, or the second depression 136b, current flows through the positive lead 134, the dial blade gap adjuster, the contacting pin, and the first contact sensor 116, forming a complete circuit. Thus, no current flows through the first contact sensor 116 when the dial blade gap adjuster 112 is being rotated between positions where the contacting pin 114 engages one of the two depressions 136a, 136b.

Similarly, the second contact sensor 118 engages the face 138 of the dial blade gap adjuster 112 at a distance equal to a radius R2 from the center of the dial blade gap adjuster. An inner semicircular non-conductive track 142 is disposed on the face 138 at a uniform radial distance equal to R2, such that a radius of curvature of the inner semicircular non-conductive track is equal to the radius R2. Advantageously, the inner semicircular non-conductive track 142 is made of plastic or another non-electrically conductive material. Advantageously, ends 144 of the inner semicircular non-conductive track 142 form a line which is offset by an angle α with a line which intersects centers of the first and second depressions 136a, 136b.

Thus, the second contact sensor 118 contacts either the face 138 of the dial blade gap adjuster 112 or the inner semicircular non-conductive track 142. Due to the offset, the second contact sensor 118 contacts the face 138, thereby forming a complete circuit between the positive lead 134, the dial blade gap adjuster 112, and the first contact sensor, when the contacting pin 114 engages the first depression 136a. However, the other end 144 of the inner semicircular non-conductive track 142 is between the center of the dial blade gap adjuster 112 and the second depression 136b, such that when the contacting pin 114 engages the second depression 136b, no current flows through the second contact sensor 118.

Advantageously, a user optionally sets a so-called zero point for the dial blade gap adjuster 112 by a zero set button 146 disposed on the housing 12. Once the user sets the zero point, rotation of the dial blade gap adjuster 112 will cause the digital display 102 to show the change in the relative position between the moving blade 36 and the stationary blade 24.

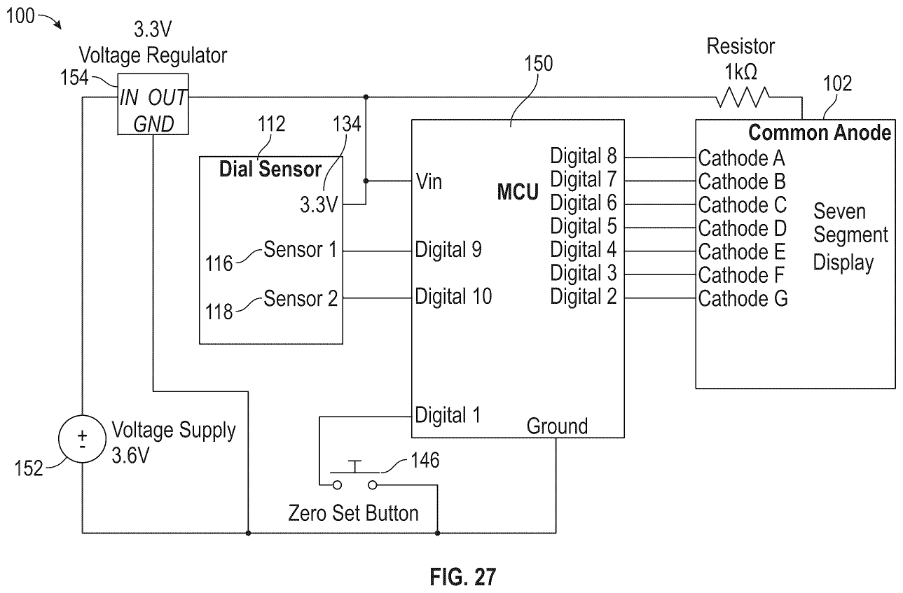

Referring now to FIGS. 16 and 27, the hair trimmer 100 includes a processing unit 150 which is connected to a battery 152 located within the housing 12. The battery 152 is connected to the positive lead 134 to provide a current to the dial blade gap adjuster 112. Additionally, the first and second contact sensors 116, 118 are connected to the processing unit 150, such that when one or both of the first and second contact sensors are engaging the face 138 of the dial blade gap adjuster 112, the processing unit registers that a complete circuit is made. Optionally, a voltage regulator is used to ensure that a particular voltage is applied by the positive lead 134 to the dial blade gap adjuster 112.

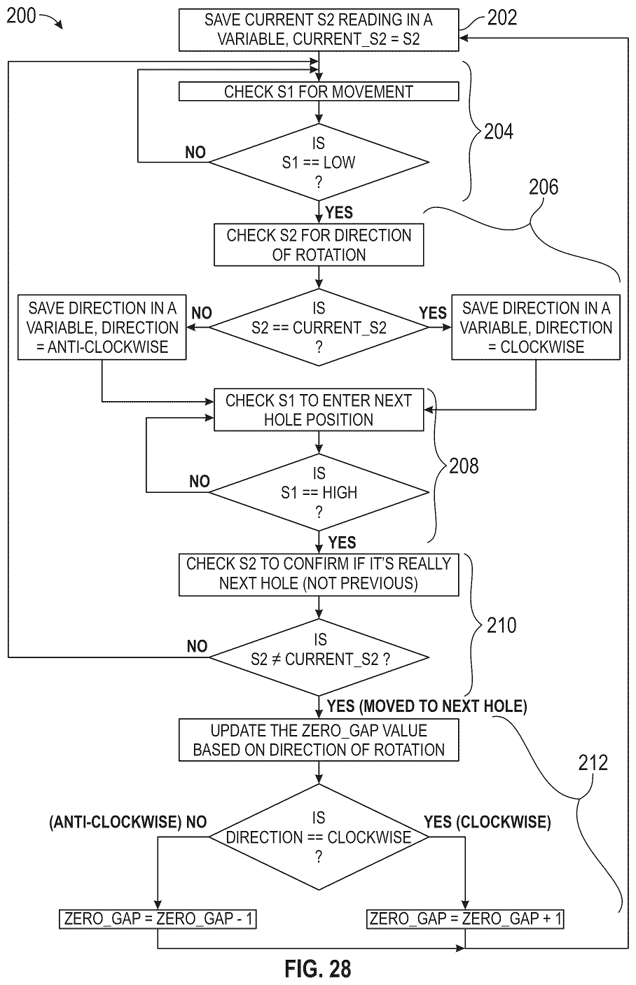

Referring now to FIG. 28, the processing unit 150 performs a method 200 for determining a position of the moving blade 34 relative to the stationary blade 24 along the direction “D”. An initial current setting step 202 includes saving the initial current registered by the processing unit 150 from the second contact sensor 118, which will have a non-zero value when the second contact sensor is engaging the face 138 of the dial blade gap adjuster 112. However, the initial current of the second contact sensor 118 registered by the processing unit 150 when the first contact sensor is contacting the inner non-conductive track 142 will be zero.

Next, the method 200 includes a first movement checking step 204 of checking the present current registered by the processing unit 150 from the first contact sensor 116, which will have a non-zero value when the contacting pin 114 is engaging one of the two depressions 136a, 136b. When there is current registered through the first contact sensor 116 then step 204 is repeated. Alternatively, when the current registered through the first contact sensor 116 is zero, the processing unit 150 detects that the contacting pin 114 is engaging one of the outer non-conductive tracks 140 and that the dial blade gap adjuster 112 is being rotated. In this case, the method 200 proceeds to a direction checking step 206.

In the direction checking step 206, the processing unit 150 determines whether the dial blade gap adjuster 112 is being rotated clockwise or counterclockwise. When the processing unit 150 determines that the present current through the second contact sensor 118 is the same as the as the initial current through the second contact sensor, then the dial blade gap adjuster 112 is rotating clockwise. However, when the processing unit 150 determines that the present current through the second contact sensor 118 is different from the initial current through the second contact sensor, then the dial blade gap adjuster 112 is rotating counter-clockwise.

Next, the method 200 proceeds to a rotation checking step 208 in which the processing unit 150 determines whether the contacting pin 114 has reached one of the two depressions 136a, 136b. When the processing unit 150 determines that the current through the first contact sensor 116 is zero, then the processing unit determines that the dial blade gap adjuster 112 has not rotated such that the contacting pin 114 is engaging one of the depressions 136a, 136b. Alternatively, when the processing unit 150 determines that the current through the first contact sensor 116 is non-zero, then the processing unit determines that the dial blade gap adjuster has rotated to a position where the contacting pin 114 has reached one of the two depressions 136a, 136b.

Then, the method 200 proceeds to a confirmation step 210 where the processing unit 150 confirms that user did not begin rotating the dial blade gap adjuster 112, stop rotating the dial blade gap adjuster, and begin rotating the dial blade gap adjuster in the opposite direction such that the dial blade gap adjuster returned to its original position. Specifically, in the confirmation step 210, the processing unit 150 determines whether the present current through the second contact sensor 118 is different from the initial current through the second contact sensor. When the present current through the second contact sensor 118 is the same as the initial current through the second contact sensor, then the user returned the dial blade gap adjuster 112 to the original position and the blade gap remained unchanged. In this case, the method 200 returns to the first movement checking step 204. Alternatively, when the present current through the second contact sensor 118 is different from the initial current through the second contact sensor, then the user has rotated the dial blade gap adjuster 112 a half rotation, and the method 200 proceeds to a blade gap updating step 212.

In the blade gap updating step 212, the processing unit updates the blade gap displayed on the digital display 102 based upon the direction in which the dial blade gap adjuster 112 was rotated. Specifically, when the processor determines that the dial blade gap adjuster 112 was rotated clockwise, the value depicted on the digital display 102 is increased by one distance increment which is dictated by thread pitch of the threaded stem 62. For example, a half rotation of the dial blade gap adjuster 112 optionally causes movement of the moving blade 36 relative to the fixed blade 26 of 0.0040 inch. Additionally, when the processor determines that the dial blade gap adjuster 112 was rotated counter-clockwise, the value depicted on the digital display 102 is decreased by one distance increment.

The systems and devices described above optionally include a control module or a computing device comprising a processing and a memory having stored computer-executable instructions for implementing the above-described processes described. The processing unit optionally includes any suitable devices configured to cause a series of steps to be performed so as to implement the method such that instructions, when executed by the computing device or other programmable apparatus, optionally causes the functions/acts/steps specified in the methods described above to be executed. The processing unit optionally includes, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory optionally is any suitable known or other machine-readable storage medium. The memory optionally includes non-transitory computer readable storage medium such as, for example, but not limited to, an electronic, magnetic, optical, electromagnetic, infrared, or semiconductor system, apparatus, or device, or any suitable combination of the foregoing. The memory optionally includes a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory also contemplates any storage configuration (e.g., devices) suitable for retrievably storing the computer-executable instructions executable by processing unit.

The methods and systems described above is optionally implemented in a high-level procedural or object-oriented programming or scripting language, or a combination thereof, to communicate with or assist in the operation of the control module or computing device. Alternatively, the methods and systems described above are optionally implemented in assembly or machine language. The language is optionally a compiled or interpreted language. Program code for implementing the methods and systems described here are optionally stored on the storage media or the device, for example a ROM, a magnetic disk, an optical disc, a flash drive, or any other suitable storage media or device. The program code is optionally readable by a general or special-purpose programmable computer for configuring and operating the computer when the storage media or device is read by the computer to perform the procedures described above.

Computer-executable instructions are optionally in many forms, including modules, executed by one or more computers or other devices. Generally, modules include routines, programs, objects, components, data structures, etc., that perform particular tasks or implement particular abstract data types. Typically, the functionality of the modules are optionally combined or distributed as desired in various embodiments.

While a particular embodiment of the present zero gap trimmer bladeset with adjuster has been described herein, it will be appreciated by those skilled in the art that changes and modifications may be made thereto without departing from the invention in its broader aspects and as set forth in the following claims.

All references, including publications, patent applications, and patents cited herein are hereby incorporated by reference to the same extent as if each reference were individually and specifically indicated to be incorporated by reference and were set forth in its entirety herein.

The term “electric hair cutting device” as used herein includes any electric hair cutting device that includes a motor which drives a moving blade to cut hair, including but not limited to hair clippers, hair trimmers, and electric shavers. The terms “hair clipper” and “hair trimmer” are used interchangeably unless otherwise noted, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A hair trimmer bladeset for a hair trimmer, comprising:
a stationary blade having a stationary blade base and a plurality of stationary blade teeth projecting from a first edge of said stationary blade base;
a moving blade having a moving blade base and a plurality of moving blade teeth projecting from a first edge of said moving blade base, said moving blade constructed and arranged to reciprocate laterally relative to said stationary blade;
a blade guide secured to said moving blade;
said moving blade configured for being slidably adjusted relative to said stationary blade and said blade guide in a direction transverse to said reciprocation; and
an adjuster associated with said blade guide and configured for moving said moving blade relative to said stationary blade upon a manipulation of said adjuster.

2. The hair trimmer bladeset of claim 1, wherein said adjuster includes a stem that is threadably engaged in said blade guide.

3. The hair trimmer bladeset of claim 2, wherein said adjuster is manipulated by rotating a wheel connected to said stem for rotating said stem relative to said blade guide.

4. The hair trimmer bladeset of claim 3, wherein said wheel rotatably engages a slot in said moving blade.

5. The hair trimmer bladeset of claim 3, wherein said wheel is configured for being rotated by a tool.

6. The hair trimmer bladeset of claim 1, wherein said blade guide engages a track in said stationary blade base, and is provided with a vertically projecting adjuster housing configured for threadably accommodating a stem of said adjuster.

7. The hair trimmer bladeset of claim 1, further including a cam follower mounted to said moving blade, configured for receiving a drive member associated with the hair trimmer, and being mounted upon said blade guide.

8. The hair trimmer bladeset of claim 7, wherein said adjuster is accessible by a user through said cam follower.

9. The hair trimmer bladeset of claim 7, wherein said cam follower is provided with locating lugs extending into complementary openings in said moving blade base for alignment control of said moving blade.

10. A hair trimmer bladeset for a hair trimmer, comprising:
a stationary blade having a stationary blade base and a plurality of stationary blade teeth projecting from a first edge of said stationary blade base;
a moving blade having a moving blade base and a plurality of moving blade teeth projecting from a first edge of said moving blade base, said moving blade constructed and arranged to reciprocate laterally relative to said stationary blade;
a blade guide secured to said moving blade and configured for engaging a track in said stationary blade base;
said moving blade configured for being slidably adjusted relative to said stationary blade and said blade guide in a direction transverse to said reciprocation;
a cam follower configured for being driven by a drive member associated with the hair trimmer, said cam follower mounted to said blade guide; and
an adjuster associated with said blade guide, being accessible through said cam follower and configured for moving said moving blade relative to said stationary blade upon a manipulation of said adjuster.

11. The hair trimmer bladeset of claim 10, wherein said cam follower is provided with locating lugs extending into complementary openings in said moving blade base for enhanced alignment control of said moving blade.

12. The hair trimmer bladeset of claim 10, wherein said adjuster is a wheel connected to a stem threadably engaging said blade guide, said wheel configured for said manipulation by a user, and configured for accommodating a tool for optional rotation of said stem.

13. A hair trimmer, comprising:
a housing;
a stationary blade mounted to said housing and having a stationary blade base and a plurality of stationary blade teeth projecting from a first edge of said stationary blade base;
a moving blade having a moving blade base and a plurality of moving blade teeth projecting from a first edge of said moving blade base, said moving blade constructed and arranged to reciprocate laterally relative to said stationary blade;
a blade guide secured to said moving blade;
said moving blade configured for being slidably adjusted relative to said stationary blade and said blade guide in a direction transverse to said reciprocation;
an adjuster associated with said blade guide and configured for moving said moving blade relative to said stationary blade by a manipulation of said adjuster; and
a processing unit configured to detect said manipulation of said adjuster.

14. The hair trimmer of claim 13, further comprising a digital display disposed on said housing, said digital display being connected to said processing unit, and being configured to display a blade gap between said moving blade and said stationary blade.

15. The hair trimmer of claim 13, wherein said adjuster is a wheel connected to a stem threadably engaging said blade guide, said wheel being configured for accommodating a tool for optional rotation of said stem.

16. The hair trimmer of claim 13, further comprising:
a first sensor which detects a rotation of said adjuster based on said manipulation, such that said processing unit registers said rotation of said adjuster and determines a change in a blade gap between said moving blade and said stationary blade based on said manipulation.

17. The hair trimmer of claim 16, wherein said first sensor includes an electrical contact which engages said adjuster, such that said first sensor detects said rotation of said adjuster based a change in a current flowing through said first sensor.

18. The hair trimmer of claim 17, further comprising:
a second sensor which detects a direction of rotation of said adjuster based on said manipulation, such that said processing unit registers said direction of rotation of said adjuster.

19. The hair trimmer of claim 18, wherein said second sensor includes an electrical contact which engages said adjuster, such that said second sensor detects said direction of said rotation of said adjuster based on a change in a current flowing through said second sensor.

20. The hair trimmer of claim 13, further including a cam follower mounted to said moving blade, configured for receiving a drive member associated with the hair trimmer, and being mounted upon said blade guide.
